(19) United States
(12) Patent Application Publication
(10) Pub. No.: US 2025/0230352 A1
(43) Pub. Date: Jul. 17, 2025

(54) SYSTEMS AND METHODS FOR STORING AN ENERGY- STORAGE FLUID WITHIN A SUBTERRANEAN FORMATION HAVING SUPPRESSED MICROBIAL ACTIVITY

(71) Applicant: BP EXPLORATION OPERATING COMPANY LIMITED, Middlesex (GB)

(72) Inventors: Shanshan Huang, Warthill (GB); Piotr Krawiec, London (GB)

(73) Assignee: BP EXPLORATION OPERATING COMPANY LIMITED, Middlesex (GB)

(21) Appl. No.: 19/007,812

(22) Filed: Jan. 2, 2025

(30) Foreign Application Priority Data
Jan. 11, 2024 (GB) 2400398.0

(51) Int. Cl. C09K 8/60; C09K 8/84; C09K 8/94; E21B 41/00

(52) U.S. Cl. CPC C09K 8/605; C09K 8/845; C09K 8/94; E21B 41/0057

(57) ABSTRACT

A method for storing an energy-storage fluid within a subterranean formation having suppressed microbial activity includes injecting a high-salinity aqueous solution into the subterranean formation via at least one injection wellbore extending from a terranean surface and penetrating the subterranean formation, such that at least a portion of the high-salinity aqueous solution is held within the subterranean formation. The high-salinity aqueous solution includes water and an inorganic salt, and is configured to suppress microbial activity in the subterranean formation. The method also includes injecting the energy-storage fluid into the subterranean formation via the at least one injection wellbore to store at least a portion of the energy-storage fluid within the subterranean formation.

### CROSS-REFERENCE TO RELATED APPLICATIONS

This application claims benefit of UK patent application Serial No. 2400398.0 filed Jan. 11, 2024, and entitled “Systems and Methods for Storing an Energy-Storage Fluid within a Subterranean Formation Having Suppressed Microbial Activity,” which is hereby incorporated herein by reference in its entirety for all purposes.

### STATEMENT REGARDING FEDERALLY SPONSORED RESEARCH OR DEVELOPMENT

Not applicable.

### BACKGROUND

Earthen subterranean formations may be used to store various foreign materials (i.e., materials that have been artificially delivered or injected into the subterranean formation) in a variety of different applications. As one example, hydrogen gas may be stored in subterranean formations. Hydrogen is a valuable and attractive energy carrier because of its high combustion performance, high heat value, and zero carbon emission characteristics. In some instances, hydrogen gas may be stored in a subterranean formation (e.g., a salt cavern, an aquifer, or a depleted hydrocarbon reservoir) to provide a ratable supply of hydrogen on demand to serve the needs of hydrogen production facilities, hydrogen fueling stations, hydrogen fuel cell applications, and large volume consumption of hydrogen facilities, such as combustion power plants and other thermally intensive facilities.

Particularly, in at least some applications, storage fluids (e.g., hydrogen gas) is injected into a subterranean formation via a wellbore which extends from the terranean surface and penetrates the subterranean formation. The hydrogen gas injected into the subterranean formation may remain stored therein during periods of low energy consumption, and may later be produced and utilized during periods of high energy consumption or demand. Other examples of subterranean formation storage systems include, carbon capture and storage (CCS), nuclear waste storage, natural gas storage, and fluids utilized in pumped hydroelectricity energy storage (PHES) systems.

### BRIEF SUMMARY OF THE DISCLOSURE

Methods for storing an energy-storage fluid within a subterranean formation having suppressed microbial activity are disclosed herein. In one embodiment, a method for storing an energy-storage fluid within a subterranean formation having suppressed microbial activity may comprise injecting a high-salinity aqueous solution into the subterranean formation via at least one injection wellbore extending from a terranean surface and penetrating the subterranean formation. The high-salinity aqueous solution may comprise water and an inorganic salt, and at least a portion of the high-salinity aqueous solution may be held within the subterranean formation. Injecting the high-salinity aqueous solution into the subterranean formation may be effective to suppress microbial activity in the subterranean formation. In addition, the method may comprise injecting the energy-storage fluid into the subterranean formation via the at least one injection wellbore to store at least a portion of the energy-storage fluid within the subterranean formation.

In another embodiment, a method for storing an energy-storage fluid within a subterranean formation having suppressed microbial activity may comprise injecting a high-salinity aqueous solution into the subterranean formation via at least one injection wellbore extending from a terranean surface and penetrating the subterranean formation. The high-salinity aqueous solution may comprise water and an inorganic salt, and at least a portion of the high-salinity aqueous solution may be held within the subterranean formation. Injecting the high-salinity aqueous solution into the subterranean formation may be effective to suppress microbial activity in the subterranean formation. In addition, the method may comprise injecting the energy-storage fluid into the subterranean formation via the at least one injection wellbore to store at least a portion of the energy-storage fluid within the subterranean formation. Further, the method may comprise repeating, and/or alternating injections of the high-salinity aqueous solution and/or the energy-storage fluid over a predefined number of cycles to suppress microbial activity and store the energy-storage fluid in the subterranean formation.

In yet another embodiment, a method for storing an energy-storage fluid within a subterranean formation having suppressed microbial activity may comprise injecting an initial gas at a first temperature into the subterranean formation via at least one injection wellbore extending from a terranean surface and penetrating the subterranean formation. The subterranean formation may be at ambient temperature. The first temperature of the initial gas may be greater than the ambient temperature of the subterranean formation. Injecting the initial gas at a first temperature into the subterranean formation may suppress microbial activity in the subterranean formation. In addition, the method may comprise continuously injecting the energy-storage fluid compressed to a second temperature, that may be different or equal to the first temperature, into the subterranean formation via the at least one injection wellbore for a predefined period of time, to store at least a portion of the energy-storage fluid within the subterranean formation. The second temperature of the energy-storage fluid may be greater than the ambient temperature of the subterranean formation. Injecting the energy-storage fluid compressed to a second temperature for the predefined period of time into the subterranean formation may be effective to suppress microbial activity in the subterranean formation.

In still yet another embodiment, a method for storing an energy-storage fluid within a subterranean formation having suppressed microbial activity may comprise injecting a high-salinity aqueous solution into the subterranean formation via at least one injection wellbore extending from a terranean surface and penetrating the subterranean formation. The high-salinity aqueous solution may comprise water and an inorganic salt. Injecting the high-salinity aqueous solution into the subterranean formation may be effective to suppress microbial activity in the subterranean formation. In addition, the method may comprise continuously injecting, following injection of the high-salinity aqueous solution, an energy-storage fluid compressed to a predefined temperature into the subterranean formation via the at least one injection wellbore for a predefined period of time, to store at least a portion of the energy-storage fluid within the subterranean formation. The subterranean formation may be at ambient temperature. The predefined temperature of the energy-storage fluid may be greater than a temperature of the subterranean formation. Continuously injecting the compressed energy-storage fluid for a predefined period of time into the subterranean formation may be effective to suppress microbial activity in the subterranean formation.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of disclosed exemplary embodiments, reference will now be made to the accompanying drawings in which:

FIG. 1 is a schematic illustration of an embodiment of a system for storing an energy-storage fluid within a subterranean formation having suppressed microbial activity in accordance with principles disclosed herein;

FIG. 2 is a schematic illustration of another embodiment of a system for storing an energy-storage fluid within a subterranean formation having suppressed microbial activity in accordance with principles disclosed herein;

FIG. 3 is a graphical illustration of an exemplary relationship between salinity and temperature in accordance with principles disclosed herein;

FIG. 4 is a flowchart of an embodiment of a method for storing an energy-storage fluid within a subterranean formation having suppressed microbial activity in accordance with principles disclosed herein;

FIG. 5 is a flowchart of another embodiment of a method for storing an energy-storage fluid within a subterranean formation having suppressed microbial activity in accordance with principles disclosed herein;

FIG. 6 is a flowchart of another embodiment of a method for storing an energy-storage fluid within a subterranean formation having suppressed microbial activity in accordance with principles disclosed herein;

FIG. 7 is a flowchart of another embodiment of a method for storing an energy-storage fluid within a subterranean formation having suppressed microbial activity in accordance with principles disclosed herein;

FIG. 8 is a flowchart of another embodiment of a method for storing an energy-storage fluid within a subterranean formation having suppressed microbial activity in accordance with principles disclosed herein; and

FIG. 9 is a flowchart of another embodiment of a method for storing an energy-storage fluid within a subterranean formation having suppressed microbial activity in accordance with principles disclosed herein;

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim.

The term “couple” or “couples” is intended to mean either an indirect or direct connection. Thus, if a first device couples to a second device, that connection may be through a direct engagement between the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation.

As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, subterranean formations may be used in energy storage by artificially transporting fluids, for example, hydrogen gas, natural gas, water, etc., into a subterranean formation in which the fluid may remain stored for some period of time. These fluids may be referred to as energy-storage fluids. As used herein, energy-storage fluids are fluids stored in the subterranean formation for later use as a source of energy or for long term storage. In at least some applications, the energy-storage fluid may be delivered to the subterranean formation via a wellbore (e.g., an injection well) extending from the terranean surface and which penetrates the subterranean formation. In this manner, the energy-storage fluid may be conveyed from a surface assembly located at an uphole end of the wellbore and transported (e.g., via the operation of one or more surface pumps and/or compressors of the surface assembly) through the wellbore whereby the energy-storage fluid may be delivered to the subterranean formation for storage therein. In some instances, as the energy-storage fluid is injected into the subterranean formation, a portion of an original fluid in the subterranean formation may be swept from the subterranean formation (for example, into a neighboring subterranean formation or a production wellbore in fluid communication with the subterranean formation), reducing the saturation of the subterranean formation by the original fluid, thereby allowing the energy-storage fluid to be stored for future use.

One challenge for a constant supply of hydrogen gas (H₂) is safe and cost-efficient storage of H₂, for example, to bridge periods with low energy demand. For this purpose, subterranean or underground gas storage (UGS) in salt caverns, deep aquifers, and depleted oil/gas reservoirs may be utilized. However, these subterranean formations may be environments with potentially high microbial abundance and activity. Subsurface micro-organisms can use hydrogen (H₂) in their metabolism, which may lead to a variety of undesired adverse effects, such as H₂ loss, hydrogen sulphide (H₂S) formation, methane formation, acid formation, clogging, and corrosion, thus substantially reducing the volume of energy-storage fluid (e.g., hydrogen) available for use from the subterranean formation. Biocides may be injected into a subterranean formation to eliminate microbial activity. However, biocide injection is very expensive, and may be uneconomically viable. Moreover, biocide injection may be inefficient and/or ineffective in that the biocide may be absorbed by the subterranean formation near the wellbore, and thus not travel far into the subterranean formation, thereby requiring increased amounts of biocide to cover the entire storage area of the subterranean formation.

Accordingly, embodiments of systems and methods for storing an energy-storage fluid (e.g., hydrogen) in a subterranean formation having suppressed microbial activity are disclosed herein. In some embodiments, the methods and/or system comprise pre-treatment of the subterranean formation by injecting a fluid, according to the disclosure herein, into the subterranean formation thereby suppressing and/or eliminating microbial activity in the subterranean formation. For example, by manipulating environmental factors such as temperature and/or salinity according to the disclosure herein, microbial activity may be controlled, for example, suppressed, to yield a subterranean formation having suppressed microbial activity. In various embodiments, as will be disclosed herein, the fluid injected into the subterranean formation to suppress or eliminate microbial activity may be injected prior to the energy-storage fluid, after the energy-storage fluid, or may be the energy-storage fluid. More particularly, in some embodiments, the systems and methods for storing an energy-storage fluid in a subterranean formation may include a high-salinity aqueous solution which may be injected into the subterranean formation prior to injecting the energy-storage fluid such that microbial activity in the subterranean formation is suppressed or eliminated, thereby maintaining a constant, safe, and cost-efficient supply of the energy-storage fluid. For example, the high-salinity aqueous solution may be injected into or provided to the subterranean formation in a manner in which at least some of the high-salinity aqueous fluid is held within the pores of the subterranean formation, such that the presence of the high-salinity aqueous solution in the pores of the subterranean formation suppresses microbial activity in the subterranean formation. In some embodiments, the energy-storage fluid may be injected into the subterranean formation following injection of the high-salinity aqueous solution. In other embodiments, at least some of the high-salinity aqueous solution may be produced from the subterranean formation as more high-salinity aqueous solution and/or the energy-storage fluid is injected therein, for example, to maintain wellbore integrity due to injection of the high-salinity aqueous solution into the subterranean formation, causing increase in the wellbore pressure. In this example, at least one production wellbore may extend between the subterranean formation and the terranean surface at a location that is spaced from the injection wellbore through which the high-salinity aqueous solution and energy-storage fluid may be injected. In this manner, at least some of the high-salinity aqueous solution may be swept from the subterranean formation, and may flow uphole through the production wellbore, and from the production wellbore to the terranean surface, such that at least a portion of the high-salinity aqueous solution is extracted from the subterranean formation prior to and/or during the injection of the energy-storage fluid into the subterranean formation. In some embodiments, at least some of the high-salinity aqueous solution may be swept from the subterranean formation into neighboring formations in fluid communication with the subterranean formation.

Additionally, or alternatively, in some embodiments, the energy-storage fluid is compressed such that the temperature of the energy-storage fluid increases to a predefined temperature, for example, to a temperature that is greater than the temperature of the subterranean formation, and then delivered or injected into the subterranean formation with or without pre-treating with the high-salinity aqueous solution. For example, increasing the temperature of the energy-storage fluid that is injected such that a high-temperature energy-storage fluid is injected into the subterranean formation, may be effective to suppress or eliminate microbial activity within a subterranean formation thereby, making storing the energy-storage fluid in a subterranean formation simple and cost-effective. For instance, not intending to be bound by theory, reservoir simulations of hydrogen injection at 248° F. into a subsurface aquifer over a 12-hour cycle demonstrated that the near wellbore region extending 55 meters into the aquifer heated up and remained at a temperature high enough to suppress microbial activity during a hydrogen cycling process. Thus, by carefully selecting the injection temperature of the energy-storage fluid to be stored in the subterranean formation, certain microbial activity in the subterranean formation is suppressed. Moreover, and again not intending to be bound by theory, because certain micro-organisms like Proteobacteria and Euryarchaeota may be present in subterranean reservoirs (for example, hydrocarbon-producing reservoirs) even at relatively high temperatures, injection of the high-temperature energy-storage fluid may be effective to partially suppress or eliminate those micro-organisms that are most likely to be problematic. In some embodiments, the compressed high-temperature energy-storage fluid may be continuously injected into the subterranean formation for a predefined period of time, with or without first pre-treating with the high-salinity aqueous solution, to suppress microbial activity in the subterranean formation. In some embodiments, repeated and/or alternating injections of the high salinity aqueous solution, and/or energy-storage fluid may be performed to suppress microbial activity in the subterranean formation and store at least a portion of the energy-storage fluid in the subterranean formation.

Additionally, or alternatively, in some embodiments, the subterranean formation may be pre-treated by injecting a high-temperature initial gas into the subterranean formation prior to injecting the energy-storage fluid (for example, an energy-storage fluid compressed to a high temperature) into the subterranean formation. Therefore, depending on the types of microbes present in the subterranean formation, properties of the energy-storage fluid, and/or well and system parameters, the methods and systems disclosed herein may be selected and utilized for storing an energy-storage fluid in a subterranean formation having suppressed microbial activity.

One or more of the embodiments of the methods and systems disclosed herein may proceed contrary to accepted methods and systems for storing an energy-storage fluid within a subterranean formation. For example, cooling the energy-storage fluid (e.g., compressed hydrogen gas) before injecting into the wellbore is a common practice because lowering the temperature of the hydrogen gas increases the gas density, resulting in higher injection efficiency. Thus, the systems and methods disclosed herein for storing an energy-storage fluid in a subterranean formation having suppressed microbial activity may be selected based on the types of microbes present in the subterranean formation, properties of the energy-storage fluid, and/or well and system considerations.

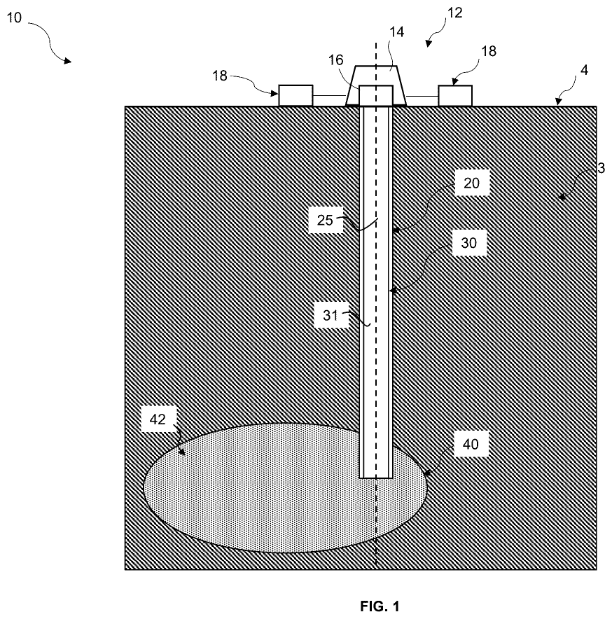

Referring now to FIG. 1, an embodiment of a system 10 for storing an energy-storage fluid within a subterranean formation having suppressed microbial activity is shown. In some embodiments, the energy-storage fluid comprises hydrogen. However, it may be understood, that the energy-storage fluid may comprise fluid other than (or in addition to) hydrogen. As shown in FIG. 1, subterranean formation 40 is generally disposed in a surrounding earthen subterranean region 3 extending beneath a terranean surface 4. Terranean surface 4 may be a land surface, a sub-sea surface (e.g., a seabed), or other underwater surface. Additionally, it may be understood that subterranean region 3 may comprise one or more subterranean formation layers or strata which are not shown in detail in FIG. 1. Subterranean formation 40 may be characterized as permeable to the transmission of fluids (e.g., liquids, gases, multi-phase fluids) therethrough and may be at least partially surrounded by one or more impermeable formations which may seal a pore space or volume of the subterranean formation 40 from the surrounding subterranean region 3 such that at least some of the fluid present within subterranean formation 40 remains stored therein over a period of time. For example, in some instances, at least part of the periphery of subterranean formation 40 may be surrounded by an impermeable cap rock layer of the subterranean region 3 while another part of the periphery of the subterranean formation 40 may be surrounded by a bedrock layer of the subterranean region 3. In some embodiments, subterranean formation 40 may fluidly or hydraulically communicate with a neighboring permeable formation (not shown in FIG. 1) of the subterranean region 3. However, in other embodiments, subterranean formation 40 may be entirely surrounded by impermeable formation(s) of subterranean region 3. Additionally, it may be understood that the configuration of subterranean region 3 may vary in other embodiments from that shown in FIG. 1.

In this exemplary embodiment, system 10 generally includes surface assembly 12 located at the terranean surface 4 (assembly 12 may thus be referred to herein as “surface equipment”), a wellbore 20 extending generally vertically from the terranean surface 4 into the subterranean region 3, and a casing string 30 extending through the wellbore 20. In general, surface assembly 12 of system 10 may include any suitable equipment for supporting or facilitating transportation of fluids, tools, and/or other materials into and from the wellbore 20. In this exemplary embodiment, surface assembly 12 includes a support structure 14 (e.g., a well head, a casing string head) pressure control equipment 16 (e.g., one or more blowout preventers, surface valving including, for example, one or more choke valves, one or more control valves) for controlling the flow rate of fluids into and from wellbore 20, and one or more fluid machines 18 (for example, one or more reciprocating pumps, one or more rotary pumps, and/or one or more rotary compressors) for transporting fluids (for example, gasses, liquids, and/or multi-phase fluids) into and from wellbore 20.

Wellbore 20 of system 10 extends vertically (relative to the direction of gravity) from an uphole end located at the terranean surface 4 into the subterranean region 3 along a central or longitudinal axis 25 and to a downhole end which penetrates and may be positioned within the subterranean formation 40 located beneath the terranean surface 4. In this configuration, wellbore 20 provides surface access to the subterranean formation 40 located within the subterranean region 3. While wellbore 20 is shown in FIG. 1 as substantially vertical, it should be appreciated that in other embodiments wellbore 20 may be horizontal or deviated and extend at an incline relative to the direction of gravity along one or more sections of the wellbore. Additionally, wellbore 20 may be formed with various dimensions (diameter) and depths. It may also be understood that wellbore 20 may be formed using a drilling system which may include, among other things, a support structure (for example, a derrick, a mast) located at the terranean surface 4, and a drilling assembly deployable into the subterranean region 3 including a drill bit for cutting into the subterranean region 3 and which is coupled to a downhole end of a drill string suspended from the surface support structure.

Casing string 30 of system 10 extends axially from a first or uphole end located proximate to terranean surface 4 (e.g. coupled to surface assembly 12) into wellbore 20. Casing string 30 is secured to a generally cylindrical sidewall of wellbore 20 via cement (or any other suitable material that has been pumped into the annulus formed between an outer surface of casing string 30 and the sidewall of wellbore 20). In this configuration, a flow path is formed along a central passage 31 of casing string 30 that extends from the terranean surface 4 and into the subterranean formation 40. In some embodiments, casing string 30 may comprise a plurality of steel casing string joints that are coupled end-to-end and installed in the wellbore 20 via a drilling system. It may be understood that in other embodiments the casing string 30 may terminate uphole from the subterranean formation 40. In other embodiments, system 10 may not include casing string 30 and wellbore 20 may instead comprise an uncased wellbore. In still other embodiments, the casing string 30 may be perforated to facilitate the flow of fluids in and out of the subterranean formation 40 into the wellbore 20. While FIG. 1 illustrates an embodiment in which wellbore 20 includes the casing string 30, in other embodiments all or portions of wellbore 20 may be uncased (for example, an “open-hole” completion) or may include a liner.

The subterranean formation 40 may comprise a porous structure with an original fluid 42 at least partially saturating the pores of the subterranean formation 40. In some embodiments, subterranean formation 40 comprises an aquifer such as a saline aquifer or a depleted hydrocarbon reservoir. However, in other embodiments, subterranean formation 40 may comprise other subsurface structures including, for example, salt caverns, carbonates, and the like.

As described above, the subterranean formation 40 may be pre-treated by injecting a high-salinity aqueous solution into the subterranean formation 40 through injection wellbore 20 prior to injecting the energy-storage fluid into the subterranean formation 40. As used herein, salinity refers to the amount of dissolved salts in a given solution, and high-salinity as used herein refers to a salt concentration greater than a salinity of the original fluid in the subterranean formation. For example, and not intending to be bound by theory, most micro-organisms do not survive at a salinity greater than 4.5 molar. Therefore, depending on the microbial community that is present in the subterranean formation 40, the well/system properties, and the size of the subterranean formation, the injection method may be designed for example, such that, a high-salinity aqueous solution having a salinity greater than the salinity of the original fluid in the subterranean formation (e.g., salinity of about 3 molar to about 8 molar) may be injected at a rate of about five hundred thousand gallons to about two million gallons per hour, for about 12 hours to about 72 hours into the subterranean formation 40 at a pressure greater than a pore pressure of the subterranean formation 40 but less than a fracture pressure of the subterranean formation 40 (for example, about 500 psi to about 2000 psi below fracture initiation pressure) so that at least some of the high-salinity aqueous solution is held in the subterranean formation 40 as the high-salinity aqueous solution flows into the subterranean formation 40 through wellbore 20, thereby suppressing microbial activity in the subterranean formation. The high-salinity aqueous solution may comprise water and one or more inorganic salts (for example, chlorides, bromides, or other salts). In some embodiments, the high-salinity aqueous solution may also contain viscosifiers, anti-corrosion material and other additives. As the energy-storage fluid is injected into the subterranean formation 40, a portion of the high-salinity aqueous solution in the subterranean formation 40 may be swept from the subterranean formation 40 into a neighboring subterranean formation or a production wellbore in fluid communication with the subterranean formation 40, reducing the saturation of the subterranean formation 40 by the high-salinity aqueous solution, thereby allowing the energy-storage fluid to be stored in the subterranean formation 40 for future use.

In some embodiments, repeated and/or alternating injection cycles of the high-salinity aqueous solution and/or the energy-storage fluid may be performed to suppress microbial activity in the subterranean formation 40. For example, and not intending to be bound by theory, the injection program may be designed such that, a high-salinity aqueous solution (for example, an aqueous solution having a molarity of at least 3, at least 4, or at least 5), may be injected at a first pre-treatment rate (for example, one million gallons per hour), for a predefined pre-treatment period of time (for example, 12 hours) into the subterranean formation 40 at a first pre-treatment pressure that is greater than a pore pressure of the subterranean formation 40 but less than a fracture pressure of the subterranean formation 40 (for example, 1000 psi below fracture initiation pressure), such that at least some of the high-salinity aqueous solution is held in the subterranean formation 40 as the high-salinity aqueous solution flows into the subterranean formation 40 through wellbore 20 thereby suppressing microbial activity. The injection of the high-salinity (e.g., 5-molar) aqueous solution may be followed by injection of the energy-storage fluid at a first storage injection rate (for example 100 tons/hour) for a first predefined storage period of time (for example, 3 days) to store the energy-storage fluid in the subterranean formation 40. In this manner, some of the high-salinity aqueous solution may flow into neighboring formations or may be produced at the surface during injection of the energy-storage fluid as discussed further below.

The foregoing (a first injection cycle comprising a first pre-treatment cycle, and a first storage injection cycle) may be repeated, by injecting the high-salinity aqueous solution at a second pre-treatment rate, second pre-treatment pressure, and for a second pre-treatment period that is different from the first pre-treatment rate, first pre-treatment injection pressure, and first pre-treatment period of the injection of the high-salinity aqueous solution such that at least a portion of the high-salinity aqueous solution is held in the subterranean formation 40. The second pre-treatment cycle may be followed by a second storage injection cycle of the energy-storage fluid with the same or different injection parameters as the first storage injection cycle. The injection cycles (pre-treatment injection cycle, and storage injection cycle) may be repeated for a predefined number of cycles (for example, 2 cycles, 3 cycles, 4 cycles) to suppress microbial activity. In some embodiments, pre-treatment of the subterranean formation by injecting the high-salinity aqueous solution may be performed over a predefined number of consecutive pre-treatment cycles, prior to injecting the energy-storage fluid into the subterranean formation. For example, 2, 3 or 4 consecutive injection cycles of high-salinity aqueous solution for 12 hours, may be performed, followed by injection of the energy-storage fluid into the subterranean formation. In this manner, injection of the high-salinity aqueous solution is performed over repeated cycles, followed by injection of the energy-storage fluid. The injection program including the number of pre-treatment injection cycles, injection rate, and injection period, will depend on the microbial community, energy-storage fluid type as well as the subterranean formation/well system parameters. In this manner, the energy-storage fluid may be injected at temperature as described above.

Additionally, or alternatively, as described above and again not intending to be bound by theory, most micro-organisms cannot survive at temperatures above 120° C. Thus, in some embodiments, the subterranean formation may be pre-treated by injecting a high-temperature initial gas that is compressed to a predefined temperature above the temperature of the subterranean formation 40 and delivered into the subterranean formation 40 thereby suppressing microbial activity. Depending on the type of microbes present and the system requirements, the subterranean formation 40 may be pre-treated by injecting a high-temperature initial gas into the subterranean formation 40 followed by injecting an energy-storage fluid, that is compressed to a higher or the same predefined temperature as the high-temperature initial gas, into the subterranean formation 40 through wellbore 20. For example, hydrogen gas, nitrogen gas, or any other suitable cushion gases, compressed to a temperature that is greater than the temperature of the subterranean formation (for example, hydrogen gas at about 125° C.) may be injected into the subterranean formation 40 to suppress microbial activity, prior to injecting the energy-storage fluid (for example, natural gas) into the subterranean formation 40 for storage therein. In some embodiments, the pre-treatment high-temperature initial gas may be the same or different from the energy-storage fluid. For example, hydrogen gas at a temperature of about 125° C. may first be injected into the subterranean formation 40 at a first pre-treatment injection rate, (for example, about 50 tons per hour), at a first pre-treatment pressure (for example, about 1000 psi below fracture initiation pressure), and for a first predefined pre-treatment period (for example, for about 12 hours). The pre-treatment with the high-temperature hydrogen gas may be followed by injecting the energy-storage fluid (for example, hydrogen or other gas) at a higher or the same temperature (for example, about 125° C. or greater), at a predefined storage injection rate (for example, about 80-100 tons per hour) for a predefined period (for example, about 7 days) to store the energy-storage fluid in the subterranean formation 40. It should be noted that the volume of a given mass of gas is directly proportional to its temperature at constant pressure, and inversely proportional to its pressure when temperature is held constant. Thus, the injection program may be designed by iteratively selecting the type of pre-treatment fluid, injection temperature, injection rate, injection pressure, and injection period, for both the pre-treatment fluid and energy-storage fluid, to suppress microbial activity while maintaining formation/system integrity and efficiency.

In some embodiments, the energy-storage fluid that may be compressed to a predefined temperature is injected into the subterranean formation 40, after pre-treating the subterranean formation 40 with the high-salinity aqueous solution. In other embodiments, the energy-storage fluid compressed to a predefined temperature may be injected into the subterranean formation without pre-treating with the high-salinity aqueous solution or the high-temperature initial gas. In some other embodiments, the compressed energy-storage fluid may be continuously injected into the subterranean formation to suppress microbial activity and store the energy-storage fluid. For example, the temperature of the energy-storage fluid may be increased above the ambient temperature of the subterranean formation (for example, about −125° C.) by compression, and continuously injected at a rate of about 80-100 tons per hour for a predefined period of time, for example, 12 hours, 24 hours, 48 hours, 3 days, 4 days, 5 days, 6 days, 7 days, 8 days, 9 days, or more as the storage requires, to suppress microbial activity in the subterranean formation 40.

In some embodiments, fluid machine 18 of FIG. 1 comprises one or more compressors which may be used to inject the high-salinity aqueous solution, the high-temperature initial gas, and/or the energy-storage fluid into the subterranean formation 40. In some embodiments, the injection of the energy-storage fluid into the subterranean formation 40 may sweep some of the original fluid and/or high-salinity aqueous solution from the subterranean formation 40 whereby the swept original fluid and/or high-salinity aqueous solution may enter a neighboring subterranean formation and/or a production well.

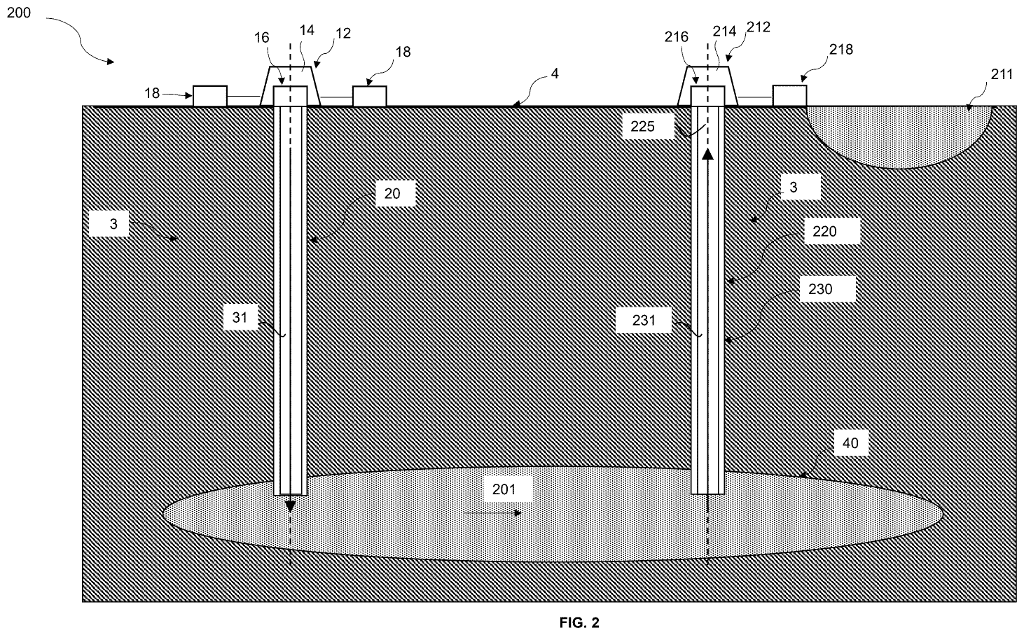

Referring to FIG. 2, an embodiment of a system 200 for storing an energy-storage fluid within a subterranean formation having suppressed microbial is shown in accordance with principles disclosed herein. In this exemplary embodiment, system 200 includes, along with system 10 which comprises an injection wellbore 20, at least one production wellbore 220 extending between the subterranean formation 40 and the terranean surface 4 at a location that is spaced along the terranean surface 4 from the injection wellbore 20 through which the high-salinity aqueous solution, high-temperature gas, and energy-storage fluid may be injected.

System 200 additionally includes a surface assembly 212 located at the terranean surface 4, the production wellbore 220 extending generally vertically from the terranean surface 4 into the subterranean region 3, and a casing string 230 extending through the production wellbore 220. In general, surface assembly 212 of system 200 may include any suitable equipment for supporting or facilitating transportation of fluids from the wellbore 220. In this exemplary embodiment, surface assembly 212 includes a support structure 214 (e.g., a well head, a casing string head), pressure control equipment 216 for controlling the flow rate of fluids into and from wellbore 220, and another fluid machine 218 for transporting fluids (e.g., gasses, liquids, and/or multi-phase fluids) from wellbore 220.

Production wellbore 220 of system 200 extends vertically from an uphole end located at the terranean surface 4 into the subterranean region 3 along a central or longitudinal axis 225 and to a downhole end which penetrates and is positioned within the subterranean formation 40 located beneath the terranean surface 4. In this configuration, production wellbore 220 communicates with and provides surface access (along with injection wellbore 20) to the subterranean formation 40 located within the subterranean region 3. While production wellbore 220 is shown in FIG. 2 as substantially vertical, it should be appreciated that in other embodiments wellbore 220 may be horizontal or deviated and extend at an incline relative to the direction of gravity along one or more sections of the wellbore. Additionally, wellbore 220 may be formed with various dimensions (diameter) and depths.

Casing string 230 of system 200 extends axially from a first or uphole end located proximate to terranean surface 4 (e.g. coupled to surface assembly 212) into wellbore 220. Casing string 230 is secured to a generally cylindrical sidewall of production wellbore 220 via cement (or any other suitable material that has been pumped into the annulus formed between an outer surface of casing string 230 and the sidewall of production wellbore 220). In this configuration, a flow path is formed along a central passage 231 of casing string 230 that extends from the terranean surface 4 and into the subterranean formation 40. In some embodiments, casing string 230 may comprise a plurality of steel casing string joints that are coupled end-to-end and installed in the production wellbore 220 via a drilling system not shown in FIG. 2. It may be understood that in some embodiments, the casing string 230 may terminate uphole from the subterranean formation 40. In other embodiments, system 200 may not include casing string 230 and production wellbore 220 may instead comprise an uncased wellbore. In still other embodiments, the casing string 230 may be perforated to facilitate the flow of fluids from the subterranean formation 40 into the production wellbore 220. While FIG. 2 illustrates an embodiment in which wellbore 220 includes the casing string 230, in other embodiments all or portions of wellbore 220 may be uncased (for example, an “open-hole” completion) or may include a liner.

As described above, a high-salinity aqueous solution may be injected into the subterranean formation 40 through injection wellbore 20 prior to injecting the energy-storage fluid into the subterranean formation 40. Thus, at least some of the high-salinity aqueous solution held in the subterranean formation 40 is swept (indicated by arrow 201 in FIG. 2) by the energy-storage fluid and flows from the subterranean formation 40, uphole through the production wellbore 220, and from the production wellbore 220 to the terranean surface 4 into a surface tank 211 of system 200. In this manner, at least a portion of the original fluid 42 and/or high-salinity aqueous solution may be extracted from the subterranean formation 40 prior to and/or during the injection of the energy-storage fluid into the subterranean formation 40. In some embodiments, at least a portion of the high-salinity aqueous solution may also be displaced and produced at the terranean surface 4 through the production wellbore 220 while the energy-storage fluid is injected through wellbore 20 into the subterranean formation 40.

Particularly, a predefined volume of the energy-storage fluid may be injected into the subterranean formation 40 following injection of the high-salinity aqueous solution, at a predefined rate, at a predefined pressure that is greater than a pore pressure of the subterranean formation 40 but less than a fracture pressure of the subterranean formation 40, and for a predefined period of time.

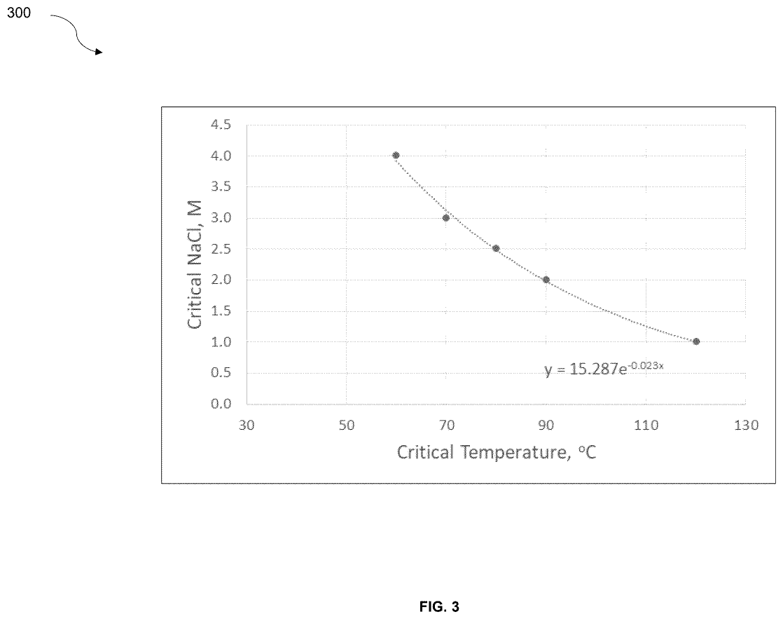

Referring now to FIG. 3, a graphical illustration 300 of an exemplary relationship between salinity and temperature in accordance with principles disclosed herein is shown. The salinity required to suppress microbial activity may depend on the temperature of the subterranean formation or the elevated temperature of the energy-storage fluid (e.g., compressed hydrogen). Graph 300 of FIG. 3 shows a plot of salinity for sodium chloride (NaCl) on the Y-axis, and temperature in degrees Celsius on the X-axis for an exemplary subterranean formation. As illustrated in graph 300 of FIG. 3, the salinity of the NaCl required decreases with increase in the temperature of the subterranean formation. The relationship may be described by equation (1) below or a similar function:

$$Salinity , M = 15.287 E - 0.023 * T , ° C . , where T = temperature \qquad Equation ( 1 )$$

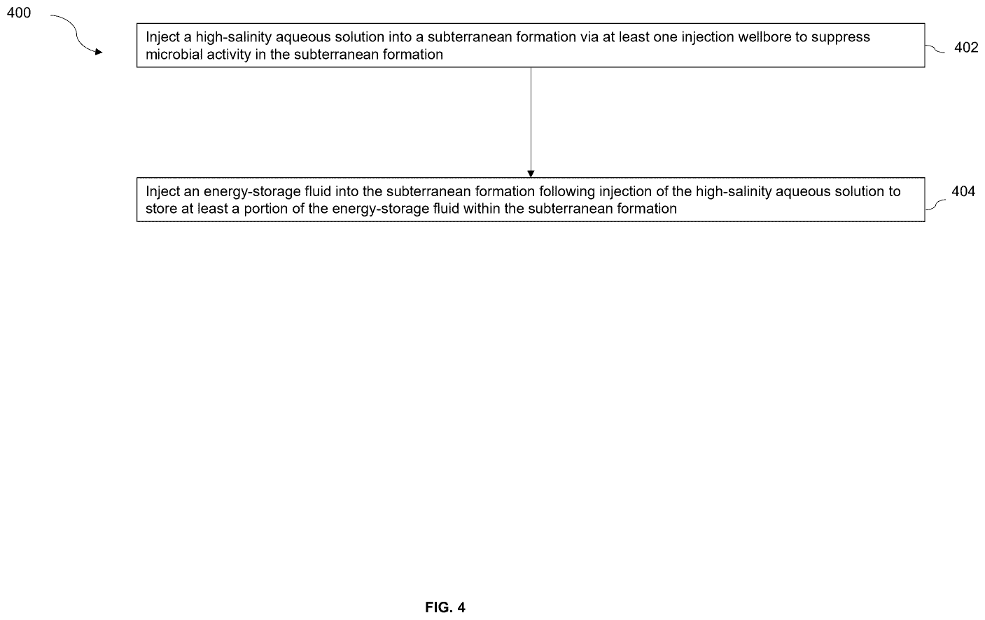

Referring to FIG. 4, a flowchart of an embodiment of a method 400 for storing an energy-storage fluid in a subterranean formation (e.g., subterranean formation 40 shown in FIGS. 1-2) having suppressed microbial activity is shown in accordance with principles disclosed herein. Initially, at block 402, method 400 comprises pre-treating the subterranean formation by injecting a high-salinity aqueous solution into a subterranean formation via at least one injection wellbore extending from the terranean surface and penetrating the subterranean formation thereby suppressing microbial activity in the subterranean formation. As described above, the salinity of the high-salinity aqueous solution may be designed depending on the type of microbial activity present and/or well and system requirements. The salinity of the high-salinity aqueous solution may be greater than a salinity of the original fluid in the subterranean formation. For example, in some embodiments, the salinity of the high-salinity aqueous solution may be at least 3.0 molar, additionally or alternatively, at least 3.5 molar, additionally or alternatively, at least 4.0 molar, additionally or alternatively, at least 4.5 molar, additionally or alternatively, at least 5.0 molar, additionally or alternatively, at least 5.5 molar, additionally or alternatively, at least 6.0 molar, additionally or alternatively, at least 6.5 molar, additionally or alternatively, at least 7.0 molar, additionally or alternatively, at least 7.5 molar, additionally or alternatively, at least 8.0 molar. In some embodiments, the high-salinity aqueous solution may be characterized as a brine.

Depending on the microbial community that is present in the subterranean formation 40, the size of the subterranean formation, and well/system parameters, the injection program may be designed such that, the high-salinity aqueous solution, may be injected at a predefined rate of, for example, about five hundred thousand to about one (1) million gallons per hour, additionally or alternatively, 1.5 million gallons per hour, additionally or alternatively, about 2 million gallons per hour for a predefined period of time, for example, about 12 hours or about 48 hours, at a predefined pressure, for example, about 500 to about 3000 psi below fracture initiation pressure, to suppress microbial activity in the subterranean formation 40.

At block 404, method 400 comprises injecting, following injection of the high-salinity aqueous solution into the subterranean formation, an energy-storage fluid into the subterranean formation via the at least one wellbore to store at least a portion of the energy-storage fluid within the subterranean formation. In some embodiments, the energy-storage fluid may be injected into the subterranean formation following injection of the high-salinity aqueous solution. In other embodiments, at least some of the original fluid and/or high-salinity aqueous solution is swept into neighboring formations as the storage fluid is injected into the subterranean formation. In some embodiments, the energy-storage fluid may be injected at a predefined rate of, for example, about 80-100 tons per hour for 24 hours, 48 hours, 3 days, 4 days, 5 days, 6 days, 7 days, 8 days, 9 days, or more into the subterranean formation for storage, at a predefined pressure, for example, about 500 to about 3000 psi below fracture initiation pressure.

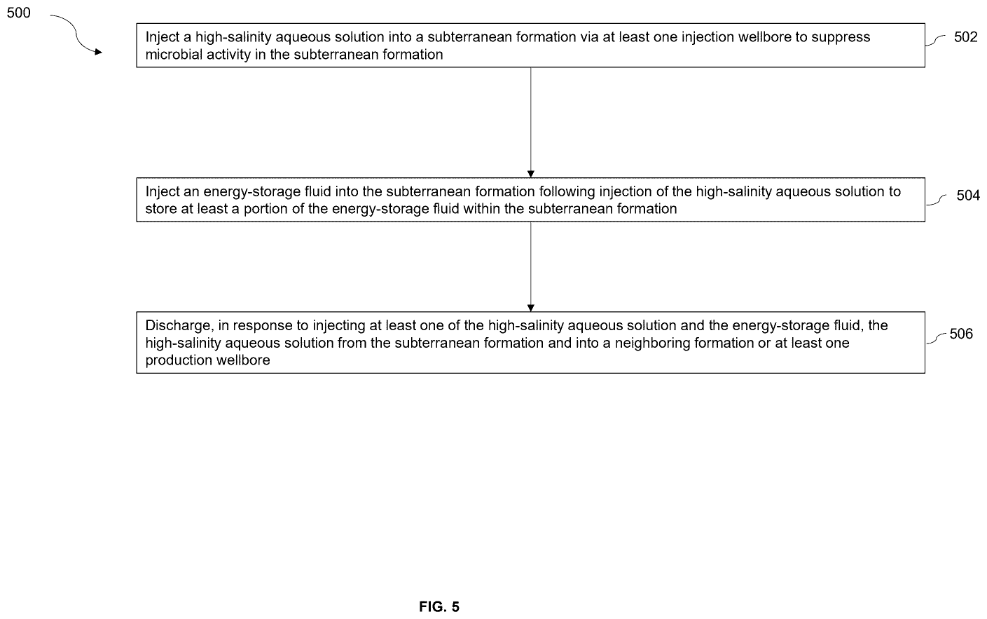

Referring to FIG. 5, a flowchart of another embodiment of a method 500 for storing an energy-storage fluid in a subterranean formation (e.g., subterranean formation 40 shown in FIGS. 1-2) having suppressed microbial activity, is shown in accordance with principles disclosed herein. Method 500 may incorporate at least some of the features or steps of method 400 described above and shown in FIG. 4. Initially, at block 502, method 500 comprises injecting a high-salinity aqueous solution into a subterranean formation via at least one injection wellbore extending from the terranean surface and penetrating the subterranean formation thereby suppressing microbial activity in the subterranean formation. At block 504, method 500 comprises injecting an energy-storage fluid into the subterranean formation via the at least one injection wellbore to store at least a portion of the energy-storage fluid within the subterranean formation. Method 500 continues at block 506 with discharging, in response to injecting at least one of the high-salinity aqueous solution and the energy-storage fluid, the high-salinity aqueous solution from the subterranean formation and into a neighboring formation or at least one production wellbore extending from the subterranean formation to the terranean surface and fluidly connected to the injection wellbore. At least some of the high-salinity aqueous brine may remain in the subterranean formation while the energy-storage fluid is being injected into the subterranean formation. In some embodiments, at least a portion of the high-salinity aqueous solution is swept from the subterranean formation and flows uphole through the production wellbore to the terranean surface. Additionally, or alternatively, in some embodiments, the high-salinity aqueous solution is discharged into the production wellbore to maintain wellbore integrity due to injection of the high-salinity aqueous solution into the subterranean formation causing increase in the wellbore pressure. In some embodiments, the original fluid in the subterranean formation of lower salinity is pushed to neighboring formations or discharged into the production wellbore as the high-salinity aqueous solution displaces the original fluid in the subterranean formation.

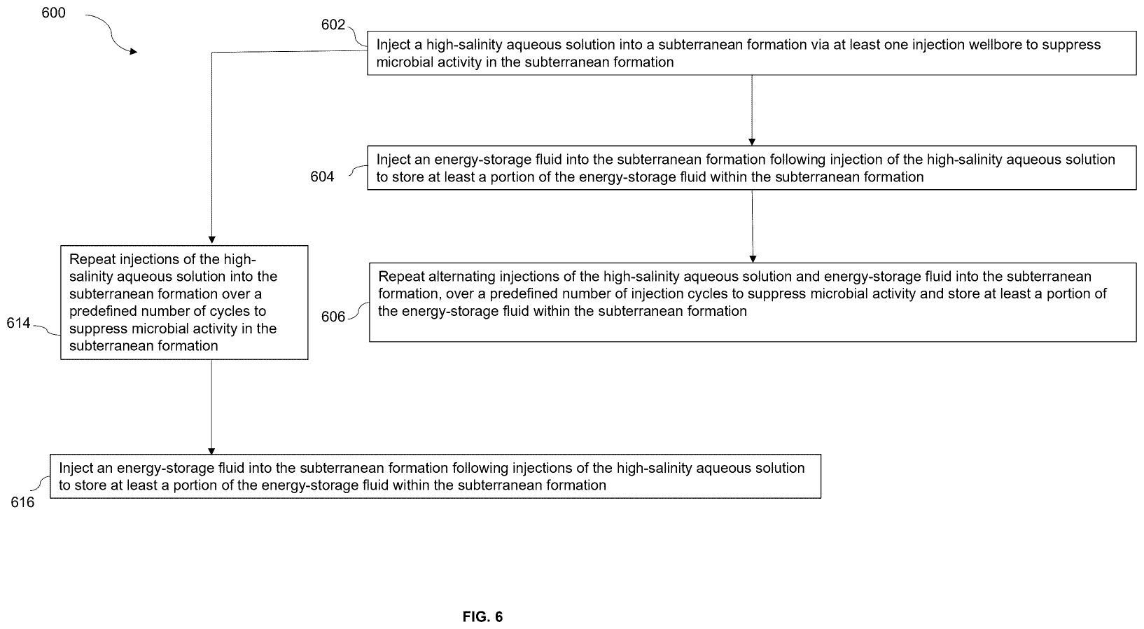

Referring to FIG. 6, a flowchart of another embodiment of a method 600 for storing an energy-storage fluid in a subterranean formation (e.g., subterranean formation 40 shown in FIGS. 1-2) having suppressed microbial activity, is shown in accordance with principles disclosed herein. Method 600 may incorporate at least some of the features or steps of method 400/500 described above and shown in FIGS. 4 and 5. Initially, at block 602, method 600 comprises injecting a high-salinity aqueous solution into a subterranean formation via at least one injection wellbore extending from the terranean surface and penetrating the subterranean formation thereby suppressing microbial activity in the subterranean formation. At block 604, method 600 comprises injecting an energy-storage fluid into the subterranean formation via the at least one injection wellbore to store at least a portion of the energy-storage fluid within the subterranean formation. Method 600 continues at block 606 with repeating alternating injections of the high-salinity aqueous solution and the energy-storage fluid over a predefined number of cycles (for example, 2 cycle, 4 cycles, 3 cycles, or 4 cycles) to suppress microbial activity in the subterranean formation as described above. Depending on the microbial community, well/system parameters, the predefined injection parameters (rate, pressure, period) may be the same or different from the predefined injection parameters of previous injection cycles. In some embodiments, method 600 may alternatively proceed from block 602 directly to block 614. At block 614, repeated injection cycles of the high-salinity aqueous solution may be performed to suppress microbial activity, and method 600 continues from block 614 to block 616 with injecting the energy-storage fluid into the subterranean formation, for storage therein. For each cycle, the injection parameters, including the injection rate, injection pressure, and injection period, for both the high-salinity aqueous solution and the energy-storage fluid will depend on the microbial community, the type of pre-treatment fluid and energy-storage fluid, as well as formation/system considerations, and may be the same or different from previous injection cycles.

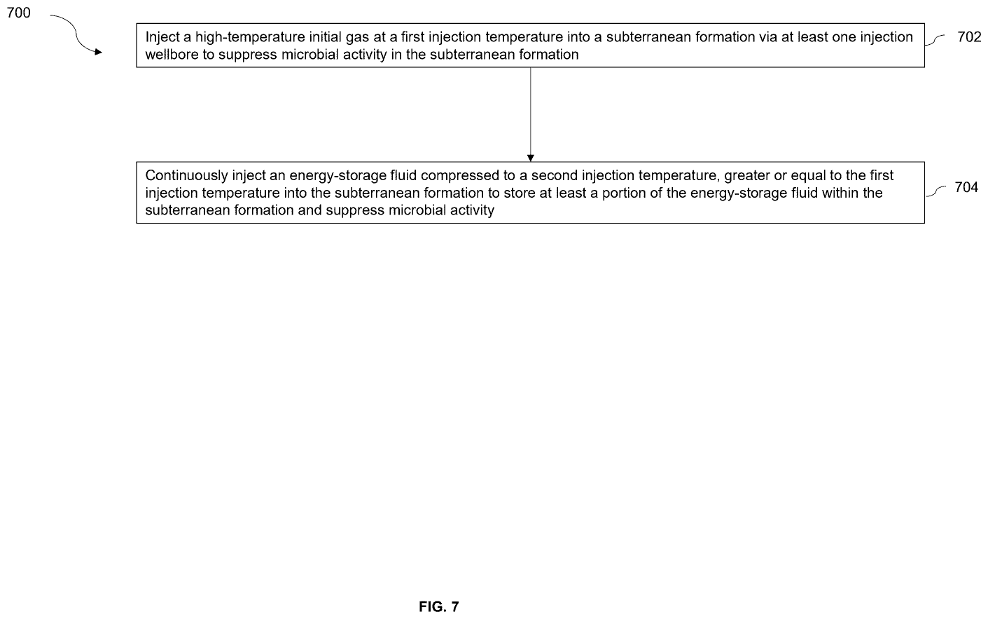

Referring to FIG. 7, a flowchart of another embodiment of a method 700 for storing an energy-storage fluid in a subterranean formation (e.g., subterranean formation 40 shown in FIG. 1-2) having suppressed microbial activity, is shown in accordance with principles disclosed herein. Method 700 may incorporate at least some of the features or steps of method 400/500/600 described above and shown in FIGS. 4, 5 and 6. Initially, at block 702, method 700 comprises injecting a high-temperature initial gas (for example, hydrogen gas, etc.) at a first temperature (For example, a high-temperature gas at 120° C.) greater than the temperature of the subterranean formation into the subterranean formation via at least one injection wellbore extending from the terranean surface and penetrating the subterranean formation thereby suppressing microbial activity in the subterranean. At block 704, method 700 comprises continuously injecting an energy-storage fluid into the subterranean formation at a second temperature, that is the same or different from the first temperature via the at least one injection wellbore for a predefined period of time, to store at least a portion of the energy-storage fluid within the subterranean formation, and thereby suppress microbial activity in the subterranean formation. For example, the energy-storage fluid may be compressed to a temperature of 120° C., 125° C., 130° C., or 135° C. and injected at a rate of about 50 tons per hour, about 60 tons per hour, or about 80-100 tons per hour for a period of about 24 hours, 48 hours, 3 days, 4 days, 5 days, 6 days, 7 days, 8 days, 9 days, or more into the subterranean formation for storage. In some embodiments, the high-temperature initial gas and the energy-storage fluid that is compressed to a predefined temperature may be the same or different.

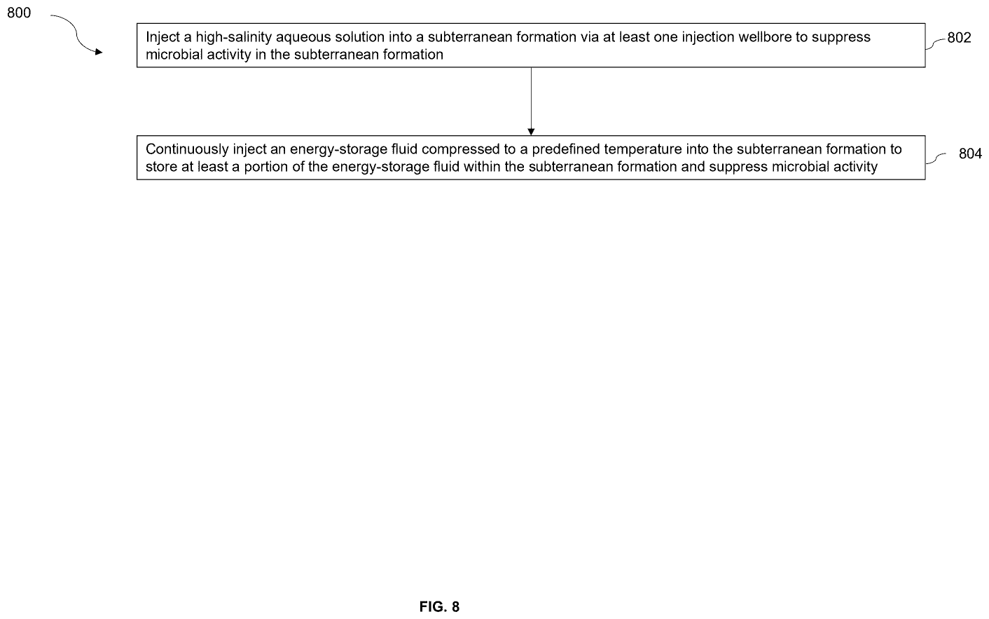

Referring to FIG. 8, a flowchart of another embodiment of a method 800 for storing an energy-storage fluid in a subterranean formation (e.g., subterranean formation 40 shown in FIG. 1-2) having suppressed microbial activity, is shown in accordance with principles disclosed herein. Method 800 may incorporate at least some of the features or steps of method 400/500/600/700 described above and shown in FIGS. 4, 5, 6 and 7. Initially, at block 802, method 800 comprises injecting a high-salinity aqueous solution into a subterranean formation via at least one injection wellbore extending from the terranean surface and penetrating the subterranean formation to suppress microbial activity in the subterranean formation. In some embodiments, a high-salinity aqueous solution may be injected into the subterranean formation at a predefined pressure, and a predefined injection rate for a predefined period. For example, in some embodiments, a high-salinity aqueous solution having a salinity of between 3.0 molar and 8.0 molar, may be injected at a rate of, for example, about one (1) million gallons per hour, for about 12 hours to suppress microbial activity. At block 804, method 800 comprises continuously injecting, following injection of the high-salinity aqueous solution, an energy-storage fluid compressed to a predefined temperature that is greater than the temperature of the subterranean formation, into the subterranean formation via the at least one injection wellbore for a predefined period of time, to store at least a portion of the energy-storage fluid within the subterranean formation and suppress microbial activity. For example, the energy-storage fluid may be compressed to a temperature of 120° C., 125° C., 130° C., or 135° C. and injected at a rate of about 80-100 tons per hour for a period of 24 hours, 48 hours, 3 days, 4 days, 5 days, 6 days, 7 days, 8 days, 9 days, or more into the subterranean formation for storage. In some embodiments, the high-salinity aqueous solution may be injected into the subterranean formation such that some of the high-salinity aqueous solution is held in the subterranean formation, thereby suppressing microbial activity.

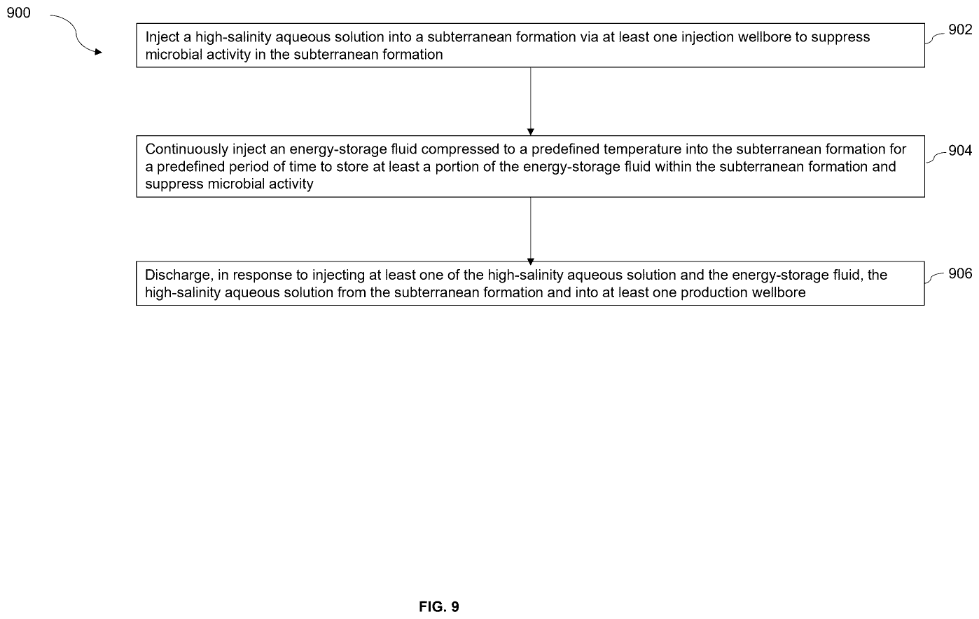

Referring to FIG. 9, a flowchart of another embodiment of a method 900 for storing an energy-storage fluid in a subterranean formation (e.g., subterranean formation 40 shown in FIG. 1-2) having suppressed microbial activity, is shown in accordance with principles disclosed herein. Method 900 may incorporate at least some of the features or steps of method 400/500/600/700/800 described above and shown in FIGS. 4, 5, 6, 7, and 8. Initially, at block 902, method 900 comprises injecting a high-salinity aqueous solution into a subterranean formation via at least one injection wellbore extending from the terranean surface and penetrating the subterranean formation to suppress microbial activity in the sub terranean formation. At block 904, method 900 comprises continuously injecting, following injection of the high-salinity aqueous solution, an energy-storage fluid compressed to a predefined temperature into the subterranean formation via the at least one injection wellbore for a predefined period of time, to store at least a portion of the energy-storage fluid within the subterranean formation and suppress microbial activity. Method 900 continues at block 906 with discharging, in response to injecting at least one of the high-salinity aqueous solution and the energy-storage fluid, the high-salinity aqueous solution from the subterranean formation and into at least one production wellbore extending from the subterranean formation to the terranean surface and hydraulically connected to the injection wellbore.

Embodiment 1 is a method for storing energy-storage fluids within a subterranean formation having suppressed microbial activity, the method comprising: injecting a high-salinity aqueous solution into the subterranean formation via at least one injection wellbore extending from a terranean surface and penetrating the subterranean formation, wherein the high-salinity aqueous solution comprises water and an inorganic salt, and wherein at least a portion of the high-salinity aqueous solution is held within the subterranean formation, and wherein injecting the high-salinity aqueous solution into in the subterranean formation suppress microbial activity in the subterranean formation; and injecting the energy-storage fluid into the subterranean formation via the at least one injection wellbore to store at least a portion of the energy-storage fluid within the subterranean formation.

Embodiment 2 is the method of embodiment 1, wherein a salinity of the high-salinity aqueous solution is greater than a salinity of an original fluid in the subterranean formation. Embodiment 3 is the method of embodiment 1, wherein a salinity of the high-salinity aqueous solution is from about 3 Molar to about 5 Molar. Embodiment 4 is the method of embodiment 1, wherein a salinity of the high-salinity aqueous solution depends on a temperature of the subterranean formation or a temperature of the energy-storage fluid and may be described by: Salinity, M=15.287E-0.023*T,° C., or a similar function. Where T is temperature. Embodiment 5 is the method of embodiment 1, wherein the energy-storage fluid comprises hydrogen. Embodiment 6 is the method of embodiment 1, further comprising discharging, in response to injecting at least one of the high-salinity aqueous solution and the energy-storage fluid, the high-salinity aqueous solution from the subterranean formation and into a neighboring formation or at least one production wellbore extending from the subterranean formation to the terranean surface, wherein the production wellbore is hydraulically connected to the injection wellbore.

Embodiment 7 is a method for storing an energy-storage fluid within a subterranean formation having suppressed microbial activity, the method comprising: injecting a high-salinity aqueous solution into the subterranean formation via at least one injection wellbore extending from a terranean surface and penetrating the subterranean formation, wherein the high-salinity aqueous solution comprises water and an inorganic salt, and wherein at least a portion of the high-salinity aqueous solution is held within the subterranean formation, and wherein injecting the high-salinity aqueous solution into the subterranean formation suppresses microbial activity in the subterranean formation; injecting the energy-storage fluid into the subterranean formation via the at least one injection wellbore to store at least a portion of the energy-storage fluid within the subterranean formation; and repeating, and/or alternating injections of the high-salinity aqueous solution and/or the energy-storage fluid over a predefined number of cycles to suppress microbial activity and store the energy-storage fluid in the subterranean formation.

Embodiment 8 is the method of embodiment 7, wherein the predefined number of cycles is from 2 cycles to 4 cycles. Embodiment 9 is the method of embodiment 7, wherein a salinity of the high-salinity aqueous solution is greater than a salinity of an original fluid in the subterranean formation. Embodiment 10 is the method of embodiment 7, wherein a salinity of the high-salinity aqueous solution is from about 3 Molar to about 5 Molar. Embodiment 11 is the method of embodiment 7, wherein a salinity of the high-salinity aqueous solution depends on a temperature of the subterranean formation or a temperature of the energy-storage fluid and may be described by: Salinity, M=15.287E-0.023*T,° C., or a similar function. Where T is temperature. Embodiment 12 is the method of embodiment 7, wherein the energy-storage fluid comprises hydrogen.

Embodiment 13 is a method for storing an energy-storage fluid within a subterranean formation having suppressed microbial activity, the method comprising: injecting an initial gas at a first temperature into the subterranean formation via at least one injection wellbore extending from a terranean surface and penetrating the subterranean formation, wherein the subterranean formation is at ambient temperature, wherein the first temperature of the initial gas is greater than the ambient temperature of the subterranean formation, and wherein injecting the initial gas at a first temperature into the subterranean formation suppresses microbial activity in the subterranean formation; and continuously injecting the energy-storage fluid compressed to a second temperature, that is different or equal to the first temperature, into the subterranean formation via the at least one injection wellbore for a predefined period of time, to store at least a portion of the energy-storage fluid within the subterranean formation, wherein the second temperature of the energy-storage fluid is greater than the ambient temperature of the subterranean formation, and wherein injecting the energy-storage fluid compressed to a second temperature for the predefined period of time into the subterranean formation suppresses microbial activity in the subterranean formation.

Embodiment 14 is the method of embodiment 13, wherein the initial gas and the energy-storage fluid comprises hydrogen. Embodiment 15 is the method of embodiment 13, wherein a continuous injection rate of the energy-storage fluid is between 50 and 100 tons per hour for a period of at least 12 hours. Embodiment 16 is the method of embodiment 13, wherein the second temperature of the energy-storage fluid is at least 60° C. Embodiment 17 is the method of embodiment 13, wherein the second temperature of the energy-storage fluid is at least 125° C.

Embodiment 18 is a method for storing an energy-storage fluid within a subterranean formation having suppressed microbial activity, the method comprising: injecting a high-salinity aqueous solution into the subterranean formation via at least one injection wellbore extending from a terranean surface and penetrating the subterranean formation, wherein the high-salinity aqueous solution comprises water and an inorganic salt; wherein injecting the high-salinity aqueous solution into the subterranean formation suppresses microbial activity in the subterranean formation; and continuously injecting, following injection of the high-salinity aqueous solution, an energy-storage fluid compressed to a predefined temperature into the subterranean formation via the at least one injection wellbore for a predefined period of time, to store at least a portion of the energy-storage fluid within the subterranean formation, wherein the subterranean formation is at ambient temperature, wherein the predefined temperature of the energy-storage fluid is greater than a temperature of the subterranean formation, and wherein continuously injecting the compressed energy-storage fluid for a predefined period of time into the subterranean formation suppresses microbial activity in the subterranean formation.

Embodiment 19 is the method of embodiment 18, further comprising discharging, in response to injecting at least one of the high-salinity aqueous solution and the energy-storage fluid, the high-salinity aqueous solution from the subterranean formation and into a neighboring formation or at least one production wellbore extending from the subterranean formation to the terranean surface, wherein the production wellbore is hydraulically connected to the injection wellbore. Embodiment 20 is the method of embodiment 18, wherein a continuous injection rate of the storage fluid is 80-100 tons/hour for a period of at least 12 hours.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A method for storing an energy-storage fluid within a subterranean formation having suppressed microbial activity, the method comprising:
injecting a high-salinity aqueous solution into the subterranean formation via at least one injection wellbore extending from a terranean surface and penetrating the subterranean formation, wherein the high-salinity aqueous solution comprises water and an inorganic salt, and wherein at least a portion of the high-salinity aqueous solution is held within the subterranean formation, and wherein injecting the high-salinity aqueous solution into in the subterranean formation suppress microbial activity in the subterranean formation; and
injecting the energy-storage fluid into the subterranean formation via the at least one injection wellbore to store at least a portion of the energy-storage fluid within the subterranean formation.

2. The method of claim 1, wherein a salinity of the high-salinity aqueous solution is greater than a salinity of an original fluid in the subterranean formation.

3. The method of claim 1, wherein a salinity of the high-salinity aqueous solution is from about 3 Molar to about 5 Molar.

4. The method of claim 1, wherein a salinity of the high-salinity aqueous solution depends on a temperature of the subterranean formation or a temperature of the energy-storage fluid and may be described by:
Salinity, M=15.287E-0.023*T, or a similar function, where T is temperature (C).

5. The method of claim 1, wherein the energy-storage fluid comprises hydrogen.

6. The method of claim 1, further comprising discharging, in response to injecting at least one of the high-salinity aqueous solution and the energy-storage fluid, the high-salinity aqueous solution from the subterranean formation and into a neighboring formation or at least one production wellbore extending from the subterranean formation to the terranean surface, wherein the production wellbore is hydraulically connected to the injection wellbore.

7. A method for storing an energy-storage fluid within a subterranean formation having suppressed microbial activity, the method comprising:
injecting a high-salinity aqueous solution into the subterranean formation via at least one injection wellbore extending from a terranean surface and penetrating the subterranean formation, wherein the high-salinity aqueous solution comprises water and an inorganic salt, and wherein at least a portion of the high-salinity aqueous solution is held within the subterranean formation, and wherein injecting the high-salinity aqueous solution into the subterranean formation suppresses microbial activity in the subterranean formation;
injecting the energy-storage fluid into the subterranean formation via the at least one injection wellbore to store at least a portion of the energy-storage fluid within the subterranean formation; and
repeating, and/or alternating injections of the high-salinity aqueous solution and/or the energy-storage fluid over a predefined number of cycles to suppress microbial activity and store the energy-storage fluid in the subterranean formation.

8. The method of claim 7, wherein the predefined number of cycles is from 2 cycles to 4 cycles.

9. The method of claim 7, wherein a salinity of the high-salinity aqueous solution is greater than a salinity of an original fluid in the subterranean formation.

10. The method of claim 7, wherein a salinity of the high-salinity aqueous solution is from about 3 Molar to about 5 Molar.

11. The method of claim 7, wherein a salinity of the high-salinity aqueous solution depends on a temperature of the subterranean formation or a temperature of the energy-storage fluid and may be described by:
Salinity, M=15.287E-0.023*T, or a similar function, where T is temperature (° C.).

12. The method of claim 7, wherein the energy-storage fluid comprises hydrogen.

13. A method for storing an energy-storage fluid within a subterranean formation having suppressed microbial activity, the method comprising:
injecting an initial gas at a first temperature into the subterranean formation via at least one injection wellbore extending from a terranean surface and penetrating the subterranean formation, wherein the subterranean formation is at ambient temperature, wherein the first temperature of the initial gas is greater than the ambient temperature of the subterranean formation, and wherein injecting the initial gas at a first temperature into the subterranean formation suppresses microbial activity in the subterranean formation; and
continuously injecting the energy-storage fluid compressed to a second temperature, that is different or equal to the first temperature, into the subterranean formation via the at least one injection wellbore for a predefined period of time, to store at least a portion of the energy-storage fluid within the subterranean formation, wherein the second temperature of the energy-storage fluid is greater than the ambient temperature of the subterranean formation, and wherein injecting the energy-storage fluid compressed to a second temperature for the predefined period of time into the subterranean formation suppresses microbial activity in the subterranean formation.

14. The method of claim 13, wherein the initial gas and the energy-storage fluid comprises hydrogen.

15. The method of claim 13, wherein a continuous injection rate of the energy-storage fluid is between 50 and 100 tons per hour for a period of at least 12 hours.

16. The method of claim 13, wherein the second temperature of the energy-storage fluid is at least 60° C.

17. The method of claim 13, wherein the second temperature of the energy-storage fluid is at least 125° C.

18. A method for storing an energy-storage fluid within a subterranean formation having suppressed microbial activity, the method comprising:
injecting a high-salinity aqueous solution into the subterranean formation via at least one injection wellbore extending from a terranean surface and penetrating the subterranean formation, wherein the high-salinity aqueous solution comprises water and an inorganic salt; wherein injecting the high-salinity aqueous solution into the subterranean formation suppresses microbial activity in the subterranean formation; and
continuously injecting, following injection of the high-salinity aqueous solution, an energy-storage fluid compressed to a predefined temperature into the subterranean formation via the at least one injection wellbore for a predefined period of time, to store at least a portion of the energy-storage fluid within the subterranean formation, wherein the subterranean formation is at ambient temperature, wherein the predefined temperature of the energy-storage fluid is greater than a temperature of the subterranean formation, and wherein continuously injecting the compressed energy-storage fluid for a predefined period of time into the subterranean formation suppresses microbial activity in the subterranean formation.

19. The method of claim 18, further comprising discharging, in response to injecting at least one of the high-salinity aqueous solution and the energy-storage fluid, the high-salinity aqueous solution from the subterranean formation and into a neighboring formation or at least one production wellbore extending from the subterranean formation to the terranean surface, wherein the production wellbore is hydraulically connected to the injection wellbore.

20. The method of claim 18, wherein a continuous injection rate of the storage fluid is 80-100 tons/hour for a period of at least 12 hours.
